(19) United States
(12) Patent Application Publication
(10) Pub. No.: US 2010/0022350 A1
(43) Pub. Date: Jan. 28, 2010

(54) VEHICLE WITH AN ENGINE AND AN AUTOMATIC TRANSMISSION

(75) Inventors: Jean-Baptiste CHAUDRON, Strasbourg (FR); David WRIGHT, Howell, MI (US); Sebastien SANDER, Plobsheim (FR); Nicolas GUYOT, Baud (FR)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/492,335

(22) Filed: Jun. 26, 2009

(30) Foreign Application Priority Data
Jun. 27, 2008 (GB) 0811770.7

(51) Int. Cl. F16H 59/14

(52) U.S. Cl. 477/121

(57) ABSTRACT

A vehicle is provided with an engine and an automatic transmission and a process for controlling an automatic transmission. In order to reduce the reaction time after a slight tip in of less than 50% during a closed throttle downshift, it is proposed to send a positive torque request to the engine at the beginning of the tip in on the accelerator. This is based on the idea to use a transmission positive torque request to force the engine to override its tip in torque management functions and provide a faster torque increase. This positive torque request at the beginning of the tip in improves considerably the engine response time. The vehicle reaction time when tipping in during a closed throttle downshift has been reduced by about 250 ms or 30%.

### CROSS-REFERENCE TO RELATED APPLICATION

This application claims priority to British Patent Application No. 0811770.7, filed Jun. 27, 2008, which is incorporated herein by reference in its entirety.

### TECHNICAL FIELD

The invention relates to a vehicle with an engine and an automatic transmission and a process for controlling an automatic transmission.

### BACKGROUND

In automatic transmissions, the response time between the tip in of the accelerator during a closed throttle downshift and the vehicle acceleration is a critical value for the driver. A current complaint reason is a too long delay after a slight tip in (less than 50% of the maximal tip in) before any car reaction, especially when braking slightly before the tip in.

For example, when the car enters a roundabout, the driver brakes and the automatic transmission goes from the third to the second gear, from then on the driver wishes to slightly reaccelerate, then the response time might seem to be too long for him. It was found out that under these conditions, the response time can be of 800 ms.

Slow engine reaction time and torque reduction request are the main contributors to this long response time. The following solutions have been tested in order to minimize the time delay between the tip in and the response.

The first approach was to increase TITM (Tip In Torque Management) limit and the exit ramp rate. During this maneuver the engine torque has difficulties to increase up to the torque limit leading to a lack of response at the beginning tip in. After the engine delay time, a higher TITM limit and exit ramp rate improve the reaction time for vehicle acceleration up to 100 ms. However, it could also lead to flares and too aggressive shift feel which is undesirable.

The second approach was the introduction of CT (closed throttle) to PDSAS (power down skip at synchronization) transition. Closed throttle to power down skip at sync transitions have been implemented for deeper throttle tip ins. The delay plateau to trigger the second downshift has been reduced. The benefit can reach 250 ms and the sporty feeling is more obvious. However, this solution may not be applied for low or medium throttle because the driver does not expect a secondary downshift in that case. Moreover, this solution does not reduce the beginning delay time. In conclusion, the two described attempts present considerable drawbacks and were therefore not applied for that particular case of slight tip in during a downshift.

It is at least one objective of the present invention to reduce the reaction time after a slight tip in of less than 50% during a downshift. In addition, other objectives, desirable features, and characteristics will become apparent from the subsequent summary and detailed description, and the appended claims, taken in conjunction with the accompanying drawings and this background.

### SUMMARY

This objective is achieved according to an embodiment of the invention in that means for sending a positive torque request to the engine at the beginning of the tip in on the accelerator are provided.

The invention is based on the idea to use a transmission positive torque request to force the engine to override its tip in torque management functions and provide a faster torque increase. This positive torque request at the beginning of the tip in improves considerably the engine response time. The vehicle reaction time when tipping in during a closed throttle downshift has been reduced by about 250 ms or about 30%, which takes the tip in hesitation to a level of customer acceptance without demeriting tip in chunk performance outside the shifts. According to the invention the positive torque request is of about 80 to about 100 Nm. The amount of the requested torque depends on the engine and the transmission and should be calibrated in function thereof. Afterwards, torque management and line pressure offset are used to control the torque increase and its effects.

A process for controlling an automatic transmission in a vehicle with an engine and an automatic transmission in which a positive torque request is sent to the engine at the beginning of the tip in on the accelerator is also within the scope of the invention.

By using the positive torque function, the transmission sends an increase torque request to the engine. Then, the engine control module deals with the airflow and the spark time to provide a faster torque increase.

In a preferred embodiment of the invention, the positive torque request is sent to the engine only if the following activation criteria are fulfilled: the driver tips in on the accelerator and keeps the foot an the pedal, the actual engine torque is lower than the torque management request, the transmission and the engine oil temperature is between about 0° C. and about 130° C.

According to an embodiment of the invention, the driver demand level is used for the torque request to avoid unexpected extra-torque. Alternatively, a maximum calibration value set to avoid flares is used for the torque request.

In a preferred embodiment of the invention, a pressure offset is used to fill the clutch faster.

### BRIEF DESCRIPTION OF THE DRAWINGS

The present invention will hereinafter be described in conjunction with the following drawing figures, wherein like numerals denote like elements, and

FIG. 1 shows the problem root cause and analysis; and

FIG. 2 shows the response time after implementation of an embodiment of the present invention.

### DETAILED DESCRIPTION

The following detailed description is merely exemplary in nature and is not intended to limit application and uses. Furthermore, there is no intention to be bound by any theory presented in the preceding background and summary or the following detailed description.

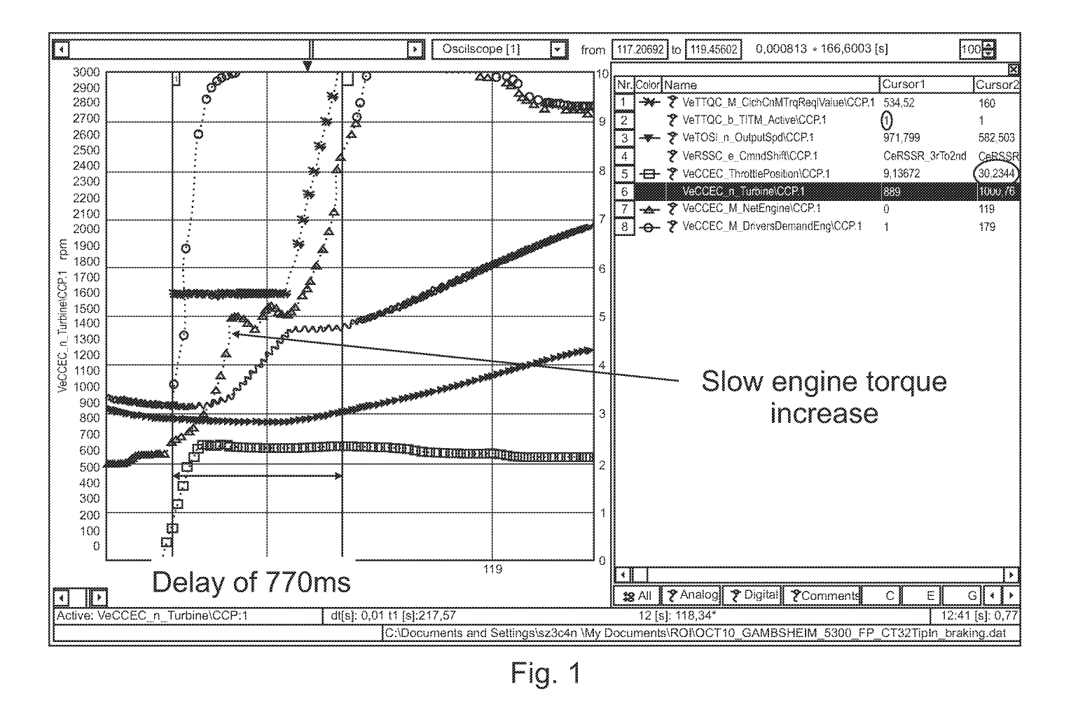

As can be seen from FIG. 1, the response time between the tip in on the accelerator (point 1) and the vehicle acceleration (point 2) is of 770 ms which is not satisfying for the customers. The graph shows that the slow engine reaction time and the torque reduction request are the main contributors to this long response time.

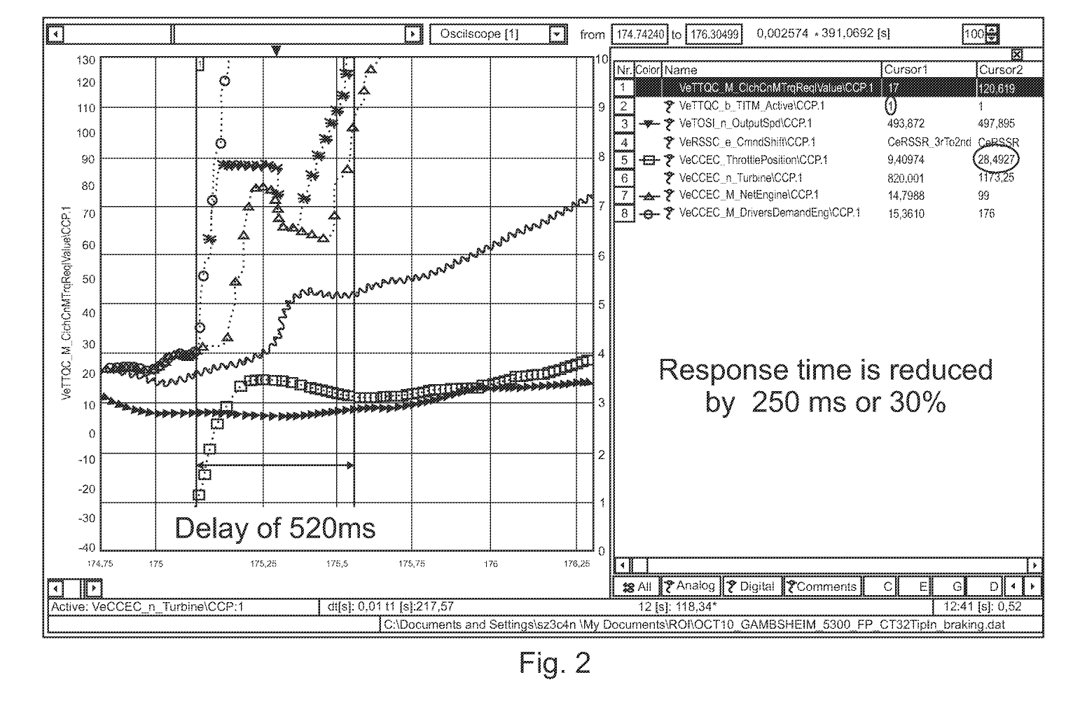

FIG. 2 shows the corresponding graph after implementation of an embodiment of the invention. By using the positive torque function, the transmission sends an “increase torque” request to the engine. Then, the engine control module deals with the airflow and spark time to provide a faster torque increase.

It can be seen that the response time between the tip in on the accelerator (point 1) and the vehicle acceleration (point 2) is now of only about 520 ms. In this case, the response time has been reduced by about 250 ms or about 30%. The attained value of about 520 ms is within the level of customer acceptance.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A vehicle, comprising:
an engine; and
means for sending a positive torque request to the engine at a beginning of a tip on an accelerator.

2. The vehicle of claim 1, wherein the positive torque request is about 80 to 100 Nm.

3. A process for controlling an automatic transmission in a vehicle with an engine, comprising the step of sending a positive torque request to the engine at the beginning of a tip on an accelerator.

4. The process of claim 3, wherein sending the positive torque request is conducted only if a driver tips on the accelerator and a foot is maintained on the accelerator, an actual engine torque is lower than the positive torque request, or a transmission and an engine oil temperature is between about 0° C. and about 130° C.

5. The process of claim 3, wherein a driver demand level is used for the positive torque request.

6. The process of claim 3, wherein a maximum calibration value set is used for the positive torque request to avoid flares.

7. The process of claim 3, wherein a pressure offset is used accelerate filling a clutch.
